(19) United States
(12) Patent Application Publication
(10) Pub. No.: US 2010/0201337 A1
(43) Pub. Date: Aug. 12, 2010

(54) Voltage regulator for low noise block

(75) Inventor: David Bradbury, Lancashire (GB)

Correspondence Address: DeMont & Breyer, LLC, 100 Commons Way, Ste. 250, Holmdel, NJ, 07733, US

(73) Assignee: ZETEX SEMICONDUCTORS PLC, Lancashire (GB)

(21) Appl. No.: 12/597,207

(22) PCT Filed: Apr. 30, 2008
(86) PCT No.: PCT/GB08/01513

§ 371 Date: Feb. 23, 2010

(30) Foreign Application Priority Data
May 2, 2007 (GB) 0708498.1

(51) Int. Cl. G05F 1/10; H04H 20/74

(52) U.S. Cl. 323/288; 455/3.02

(57) ABSTRACT

A voltage regulator comprises first and second capacitors and regulation means arranged to provide a respective regulated charging current from an input terminal to each of the capacitors. The regulation means comprises at least one device through which at least a portion of the respective charging current to at least one of the capacitors is supplied. The device is controllable with a control signal to regulate current flow through the device. The regulation means further comprises control signal supply means connected to the output terminal and arranged to provide said control signal to the device, the control signal being dependent upon voltage at the output terminal such that current flow through the device is regulated according to the voltage at the output terminal.

### FIELD OF THE INVENTION

The present invention relates to a voltage regulator, and in particular, although not exclusively, to a voltage regulator suitable for use in an LNB comprising one or more low noise amplifiers.

### BACKGROUND TO THE INVENTION

Low noise blocks (or LNBs) are well known devices which are also known as down converters as they are adapted to convert a whole band or block of frequencies to a lower band. They are typically incorporated in satellite signal receiving apparatus or dishes, and are typically arranged on the end of an arm, facing the parabolic reflector dish which then focuses the signals received from the satellite to the feed horn of the LNB. The LNB converts the received signals to lower frequencies, and then sends those lower frequency signals via a connected cable (typically co-axial cable) to the satellite receiver box.

Satellite LNBs commonly use amplifiers and controllers operating on power supplies of 5V or less, yet the power feed to the units is done at 10.5V to 21V. Hence, internal regulators are required. These can be linear.

Linear regulators typically dissipate a half or more of the power fed to an LNB. This is wasteful and causes high component temperatures and PCB/LNB housing constraints. Inductor based switch-mode regulation solves the dissipation issues but introduces severe noise problems that are expensive to solve. Pre-regulation (linear) followed by an inductor based switching converter is a popular partial solution for such noise problems but the remaining noise issues require large and costly filter/smoothing components to reduce switching noise to an acceptable level. (Standard linear voltage regulators pass directly any output load current noise to their supply input to maintain good output voltage regulation.)

Embodiments of the invention therefore aim to provide voltage regulators which obviate or mitigate at least one of the problems associated with the prior art. Particular embodiments of the invention aim to provide voltage regulators for LNBs which can provide higher efficiency, in that a significantly reduced portion of the power supply from the set top box is wasted in generating the required regulated output. Certain embodiments of the invention also aim to provide an improved LNB, and improved satellite signal receiving systems.

### SUMMARY OF THE INVENTION

According to a first aspect of the present invention there is provided a voltage regulator comprising:
an input terminal for connection to a power supply providing power at a supply voltage;
an output terminal for connection to a load to provide power to the load at a regulated voltage;
a first capacitor comprising respective first and second electrodes;
a second capacitor comprising respective first and second electrodes;
regulation means arranged to provide a respective regulated charging current from the input terminal to each of said capacitors;
switching means operable to selectively connect the first capacitor's first electrode to receive said respective regulated charging current or to the output terminal, to selectively connect the first capacitor's second electrode to the output terminal or to ground, to selectively connect the second capacitor's first electrode to receive said respective regulated charging current or to the output terminal, and to selectively connect the second capacitor's second electrode to the output terminal or to ground; and
switch control means arranged to control said switching means to alternate between a first configuration in which the first capacitor's first electrode is connected to receive said respective regulated charging current, the first capacitor's second electrode and the second capacitor's first electrode are each connected to the output terminal, and the second capacitor's second electrode is connected to ground, and a second configuration in which the second capacitor's first electrode is connected to receive said respective regulated charging current, the second capacitor's second electrode and the first capacitor's first electrode are each connected to the output terminal, and the first capacitor's second electrode is connected to ground,
wherein the regulation means comprises at least one device through which at least a portion of the respective charging current to at least one of the capacitors is supplied, the device being controllable with a control signal to regulate current flow through the device, the regulation means further comprising control signal supply means connected to the output terminal and arranged to provide said control signal to the device, the control signal being dependent upon voltage at the output terminal such that current flow through the device is regulated according to the voltage at the output terminal.

In certain embodiments the control signal supply means comprises a low pass filter arranged such that the control signal is substantially independent of output voltage components above a frequency threshold.

In certain embodiments the control signal supply means comprises:
a potential divider connected between the output terminal and ground;
an op-amp having an inverting input connected to the potential divider output by the low pass filter; and
a reference voltage source connected between a non-inverting input of the op-amp and ground.

In certain embodiments the control signal is a control voltage provided from an output terminal of the op-amp.

The regulator may further comprise an input capacitor connected between the input terminal and ground, and an output capacitor connected between the output terminal and ground. It may also comprise a regulator capacitor connected between an output of the regulation means and ground.

In certain embodiments the controllable device (controllable current source) is an FET, and said control signal is a control voltage provided to a gate of the FET.

In certain embodiments the regulation means comprises a single said device, the single device being arranged to convey the charging currents to the first and second capacitors.

In certain embodiments the single device is an FET having a drain connected to the input terminal and a gate connected to receive said control signal, and the switching means and switching control means are arranged such that in said first configuration the first capacitor's first electrode is connected to the source of the FET, and in said second configuration the second capacitor's first electrode is connected to the source of the FET.

In certain embodiments the regulation means comprises a first said device controllable with a first control signal to regulate the supply of charging current from the input terminal to the first capacitor, and a second said device controllable with a second control signal to regulate the supply of charging current from the input terminal to the second capacitor, the control signal supply means being arranged to provide said first and second control signals to the first and second devices respectively. Then, the first device may be a first FET having a drain connected to the input terminal and a source connected to the first capacitor's first electrode, and the second device may be a second FET having a drain connected to the input terminal and a source connected to the second capacitor's first electrode. The switch control means and the control signal supply means may then be arranged such that in said first configuration a control voltage is applied to the gate of the first FET to supply a regulated charging current dependent on the output voltage to the first capacitor and the second FET is non-conducting, and such that in said second configuration a control voltage is applied to the gate of the second FET to supply a regulated charging current dependent on the output voltage to the second capacitor and the first FET is non-conducting.

In certain embodiments the voltage regulator comprises a plurality of said input terminals, each input terminal being adapted for connection to a respective power supply providing power at a respective supply voltage, and the regulation means is arranged to provide a respective regulated charging current from the input terminals to each of said capacitors. The regulation means then comprises a plurality of said devices, each device corresponding to a respective one of said input terminals and being arranged to convey charging current to the first and second capacitors from the respective input terminal, the control signal supply means being arranged to provide a respective said control signal to each said device such that current flow through each device is regulated according to the voltage at the output terminal.

Another aspect of the invention provides a low noise block (LNB) (which may also be referred to as an LNA) comprising a voltage regulator in accordance with the first aspect.

In certain embodiments the LNB further comprises connection means for connecting a cable from a receiver box such that the receiver box can provide power to the LNB via the cable, the input terminal of the voltage regulator being connected to the connection terminal.

In certain embodiments the LNB further comprises a filter network (e.g. a DiSEqC network) connected between the connection means and the input terminal. The filter network may comprise an inductance, a capacitance, and a resistance in parallel with each other.

In certain embodiments the LNB further comprises a plurality of connection means, each connection means being adapted for connecting a respective cable from a respective receiver box such that the receiver box can provide power to the LNB via the cable, each input terminal of the voltage regulator being connected to a respective one of the connection terminals.

In certain embodiments the LNB is adapted to output signals via the connection means and the or each cable to the or each receiver box.

In certain embodiments the further comprises at least one amplifier (e.g. a low noise amplifier) connected to the output terminal to receive power at a regulated voltage.

Another aspect provides a satellite signal receiving system comprising an LNB, a receiver box connected to the LNB by a cable and arranged to supply power to the LNB via the cable at a supply voltage, the LNB comprising a voltage regulator in accordance with the first aspect, and the input terminal being connected to the cable, whereby the voltage regulator is operable to provide power at a regulated voltage.

### BRIEF DESCRIPTION OF THE DRAWINGS

Embodiments of the invention will now be described with reference to the accompanying drawings, of which:

FIG. 1 is a circuit diagram of a voltage regulator embodying the invention incorporated in an LNB and connected to receive power via a signal cable SC from a set top box;

FIG. 2 is a representation of the switch control waveforms applied to the gates of the FETs of the switching means of the voltage regulator of FIG. 1. (i.e. the figure illustrates the switched capacitor converter drive waveform timing);

FIG. 3 is a circuit diagram of another voltage regulator embodying the invention;

FIG. 4 is a circuit diagram of another voltage regulator embodying the invention and incorporated in an LNB connected to a set top box;

FIG. 5 is a representation of the voltage waveforms used to control the gates of the FETs of the switching means of the voltage regulator of FIG. 4;

FIG. 6 is a circuit diagram of another voltage regulator embodying the invention; and

FIG. 7 is a block diagram of part of another LNB embodying the invention.

### DETAILED DESCRIPTION OF EMBODIMENTS OF THE INVENTION

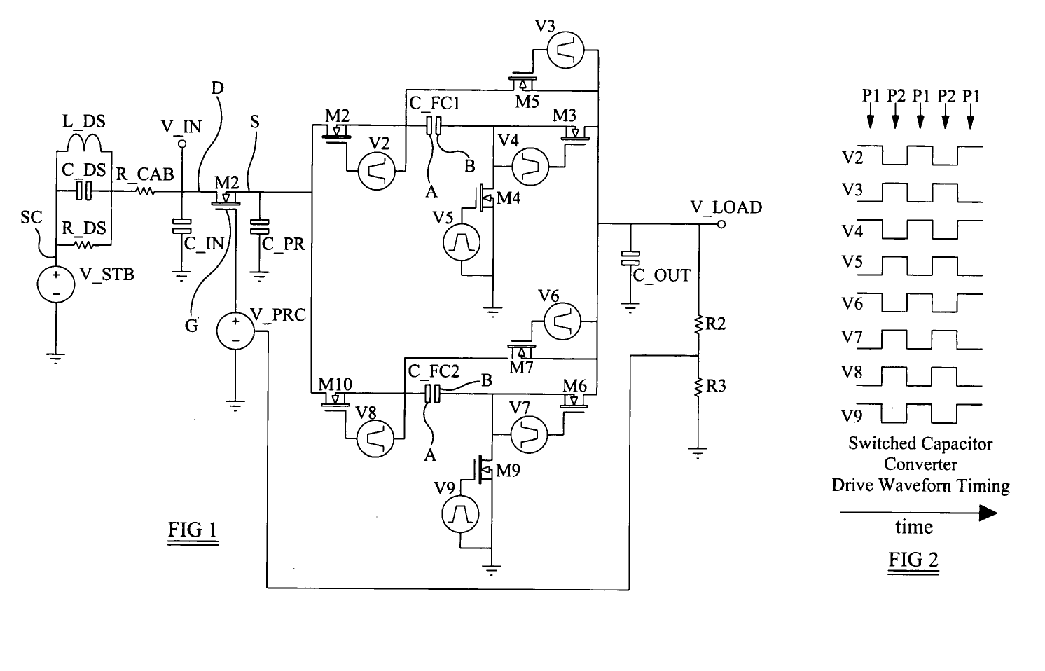

Referring now to FIG. 1., this shows the core elements of an embodiment of the invention in a Single Universal LNB (a single output unit). Voltage source Vstb represents the Set Top Box that both powers the LNB and receives RF signals from the same. Lds, Cds and Rds represent a DiSEqC filter network that is used to allow 22 kHz control signals to be inserted onto the power line. This network has an unwanted side effect of raising the low frequency impedance of the line, making it much easier to cause interference with noisy loads. Source Vprc and the fet it drives (M_PR) performs the pre-regulator function (i.e. they form part of the regulation means). This regulation means can also be described as linear regulation means. The linear pre-regulator is followed by a two-phase switch-capacitor DC/DC converter. Phase 1 uses pulse generators V2, V3, V4, V5 and the fets they drive. Phase 2 uses pulse generators V6, V7, V8, V9 and the fets they drive. Each phase uses the generators/fets to alternately charge a ‘flying capacitor’ (Cfc1/Cfc2) by connecting it between the output of the pre-regulator and the load (Cout), then once charged, re-connecting it across the load directly.

Since capacitors Cfc1 and Cfc2 supply current to the load during charge and discharge cycles but only take current from the pre-regulator during charge cycles, the input current of the converter is half the output current. (This is possible because the pre-regulator output voltage is twice or more than the voltage on Cout.). Hence the load placed on Vstb is half that of a standard LNB using linear power regulators.

Since a two phase converter has been used, at any one time either Cfc1 or Cfc2 will be taking current from the pre-regulator (and hence Vstb). This means that the input current of the pre-regulator is continuous rather than switched. Consequently the input line needs very little smoothing to keep line noise at acceptable levels, despite the use of a DiSEqC network in the line supply. The cost of the semiconductors used in an integrated two phase converter is not significantly more than that of a single phase device because its power fets can be half size as they only need to supply half the load current. The approach does require an extra flying capacitor but this component is not expensive.

Thus, in FIG. 1, the voltage regulator circuit comprises a first capacitor (flying capacitor Cfc1) having a first electrode A and a second electrode B, and a second capacitor (flying capacitor Cfc2) also having a respective first electrode A and second electrode B. The input terminal for connection to a power supply is Vin and the output terminal for connection to a load to provide power to the load at regulated voltage is Vload. In addition to the two flying capacitors Cfc1 and Cfc2, there is also an output capacitor Cout connected between the output terminal and ground, an input capacitor Cin connected between the input terminal and ground, and a further pre-regulator capacitor Cpr connected between the nominal output of the pre-regulator (or regulation means) and ground. The switching means comprises eight FETs M2-M4 and M6-M7 and M9-M10. The regulation means in this example comprises a single FET (M_PR) whose drain D is connected to the input terminal, whose source S is arranged for selective connection to the flying capacitors, and whose gate G is provided with a control signal in the form of a control voltage derived from (and dependent upon) the output voltage at the output terminal. The switching means is operable to selectively connect the first capacitor's (Cfc1) first electrode A to the source of the FET M_PR or to the output terminal, to selectively connect the first capacitor's second electrode B to the output terminal or ground, to selectively connect the second capacitor's (Cfc2) first electrode A to the source of FET M_PR or to the output terminal, and to selectively connect the second capacitor second electrode B to the output terminal or to ground. The voltage regulator further comprises switch control means arranged to provide the control voltages or signals V2-V9 to the gates of the switching FETs, and these voltage waveforms are shown in FIG. 2. As can be seen from the figure, the set of voltage wave forms alternate between a first configuration or phase P1 and a second configuration or phase P2. In the first phase P1 the first capacitor's first electrode A is connected to the source of the pre-regulator FET and the second electrode B of the first capacitor and the second capacitor's first electrode A are connected to the output terminal. Also in this first phase P1 the second capacitor's second electrode B is connected to ground. Thus, in this first phase the first capacitor is being charged (i.e. it is being supplied with a charging current via the pre-regulator's FET) and at the same time output current to an attached load can be provided from the second capacitor which is connected between the output terminal and ground. In the second phase the situation is essentially reversed, such that the first electrode of the second capacitor is now connected to the pre-regulator FET to receive charging current, and its second electrode and the first electrode of the first capacitor are connected to the output terminal. The second electrode of the first capacitor is connected to ground. Thus, in the second phase the second capacitor is being charged and output current can be provided from the first capacitor. Thus, at any one time one of the capacitors is being charged and the other is providing any required output current. It will be appreciated that the two-capacitor arrangement shown in FIG. 1 controlled according to the control signals illustrated in FIG. 2 results in the output voltage at the output terminal being approximately half the voltage of the source of the pre-regulator's FET.

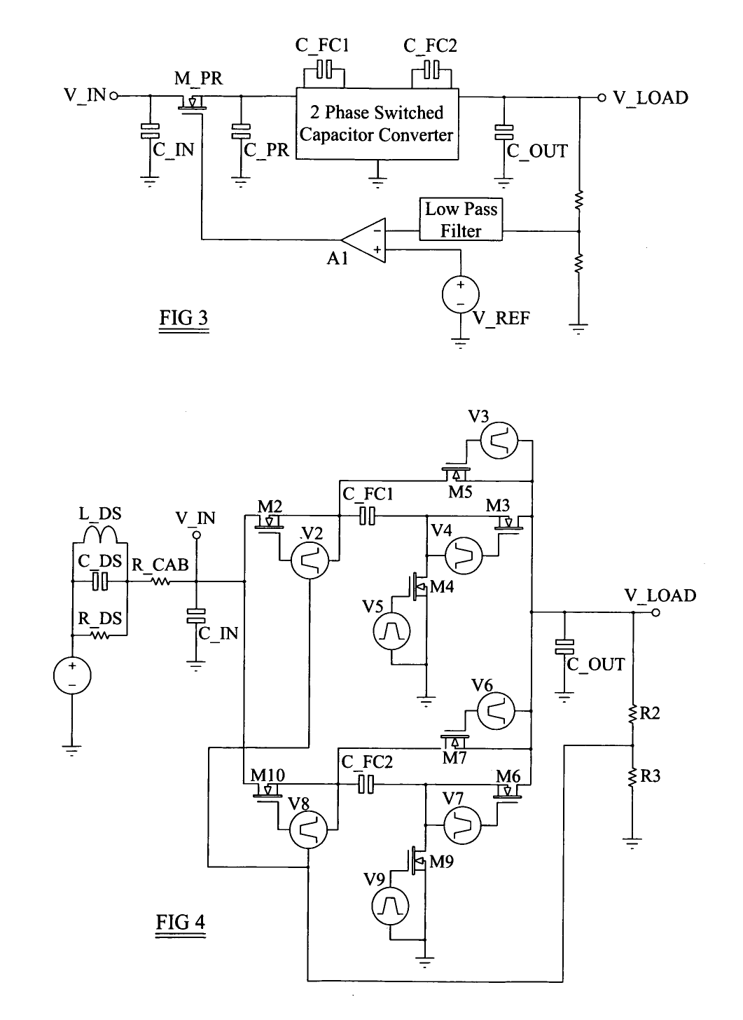

In embodiments of the invention, such as that shown in FIG. 1, the output voltage of the switched capacitor converter is monitored and used to control the pre-regulator source Vprc, providing an output voltage control loop. To maintain the noise rejection function of the pre-regulator, the response of this control is preferably limited using a low-pass filter. FIG. 3 shows in more detail an example of how this can be achieved. In this voltage regulator circuit embodying the invention, the output of the switched capacitor converter is compared with an accurate voltage reference V_REF to produce an error signal that is in turn used to set the drive signal to the pre-regulator fet. The circuit ensures that the input to the converter is maintained at precisely the voltage necessary to give the output required.

An alternate version of the invention, targeting Single LNBs only (i.e. for incorporation specifically in single LNBs), is illustrated in FIG. 4. In this embodiment the function of the weak pre-regulator is combined with the switched-capacitor converter. To achieve this, the drive voltage provided by generators V2 and V8 has been made Output voltage dependent (the output voltage again being monitored using a voltage divider R2,R3 connected across the output) so that they take over the regulation function previously provided by Vprc and its associated FET. This saves the area (and hence cost) of the series connected power FET. The modified gate control signals are shown in FIG. 5. Note in the timing diagram that the level of drive supplied by V2 and V8 is reduced compared with the other drive signals as a consequence of the regulation control.

Thus, from FIG. 4 and the above description it will be appreciated that in this embodiment the need for a dedicated FET in the regulation means to provide current to both flying capacitors has been avoided. Instead, the FETs M2 and M10 are effectively shared between the switching means and regulation means of the circuit. Rather than simply being switched fully on or off with appropriate control signals, these two FETs are instead supplied with a control voltage whose magnitude is dependent upon (i.e. derived from) the output voltage at the output terminal so that the degree to which they are switched on is regulated according to the output voltage.

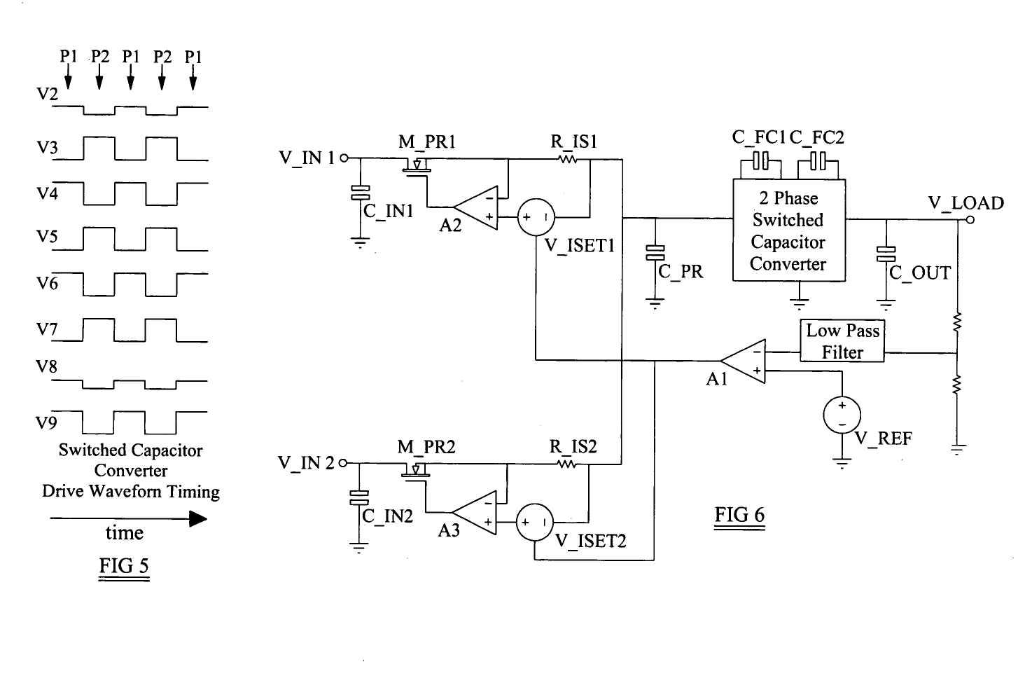

An alternate version of the invention is shown in FIG. 6. This includes multiple Vprc generators and associated fets. This form of voltage regulator is particularly suited for incorporation in multiple output LNBs (which are intended to provide signals to, and to receive power from, several receiver boxes connected with respective cables). Control of the pre-regulator circuits is arranged to ensure that all connected Vstb sources supplied roughly equal current, regardless of their output voltage (polarization state). In FIG. 4. the pre-regulators have been designed to demand an input current that is adjusted to give the required output voltage from the switched capacitor converter. Using identical input stages driven by the same control signal causes the input current to be equally shared between the two (or more) inputs (set top boxes, STBs).

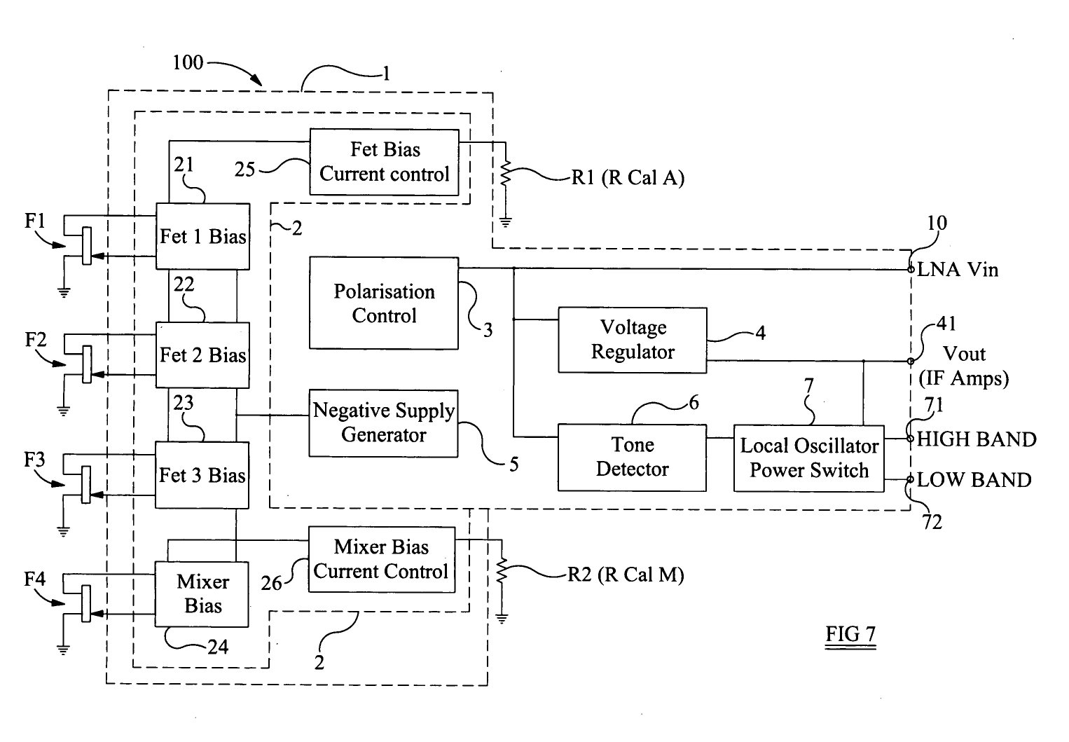

Referring now to FIG. 7, this shows part of another LNB embodying the invention, and which may also be referred to as a Low Noise Amplifier, or LNA.

LNAs are a well-known type of electronic amplifier used in communication systems to amplify very weak signals captured by an antenna. They are typically located at the antenna and are designed so as to add very little noise to the received signal. The LNAs amplify the received signals to a level required by subsequent receiving equipment to which the LNA is attached. They may also be referred to as signal boosters.

One known application of LNAs is to receive and amplify direct broadcast satellite (DBS) signals, and LNAs adapted for this purpose may be referred to as DBS LNAs. DBS LNAs typically comprise a number of FETs (which may be GaAs FETs) for processing radio frequency (RF) signals. For example, the DBS LNA may be adapted to receive signals having two different polarisations, and two FETs may be used to select which one of the input signal polarisations is amplified and passed on to subsequent connected equipment. Also, a FET may be arranged in an active mixer circuit to receive an RF input, with the gate or drain of the FET being driven by a signal from a local oscillator in the LNA. The active mixer circuit is then able to output (i.e. extract) an intermediate frequency (IF) signal.

DBS LNAs are typically required to detect very low-level RF signals covering a wide frequency range, and provide high channel-to-channel isolation. They should also be able to amplify received signals whilst introducing negligible noise, and be controllable to select between different input signal polarisations (as discussed above). It is known for them to be controllable to band switch so as to be able to receive and process signals over an increased frequency range. It is known for them to be able to down convert, that is to be able to receive an input signal at a particular frequency and output a corresponding signal at a lower frequency. Another feature of known DBS LNAs is cable drive, that is the LNA is powered and controlled via the same RF cable that is used for downfeeding the RF output of the LNA to connected equipment (such as a “set top box”).

In the past, DBS LNAs have typically incorporated a number of separate internal circuit blocks on a printed circuit board (PCB), these blocks including: a block providing FET bias control and protection stages; a block arranged to generate a negative supply voltage for use in FET control; a block arranged to detect the level of a DC input voltage for use in polarisation switch control; a block arranged to detect an AC input voltage for use in band switch control; a block arranged to control switching of power to local oscillators, and block arranged to provide a regulated power supply. These numerous separate blocks in known LNAs had to be accommodated on relatively large area PCBs, and have taken up 50% or more of the total LNA PCB area. This has added cost to the overall LNA, this cost not just being associated with the separate components and the PCB (which has typically been made from expensive low-loss RF material), but also the LNA housing material (alloy and plastic).

Referring again to FIG. 7, this illustrates part of a DBS LNA embodying the invention, and which incorporates a monolithic support IC 1 which is itself also an embodiment of the invention. In addition to the support IC 1, the LNA comprises a number of external components, which include four FETs F1, F2, F3 & F4 and two calibration resistors R1 and R2. Electrical power to operate the LNA is supplied to power input terminal 10 and the support IC 1 includes a voltage regulator 4 in accordance with the first aspect of the present invention arranged to generate a regulated voltage supply from that power input for powering both on-chip and off-chip components. The support IC 1 includes a FET control circuit 2 which is arranged to monitor and control the drain currents of each FET and generally to set the bias conditions (in terms of bias currents and bias voltages) for all of the external FETs.

This FET control circuit 2 can be regarded as comprising first, second and third stages 21, 22, 23 arranged to control the bias of FETs F1, F2 & F3 respectively. A fourth stage 24 controls the bias of FET F4 which is arranged in a mixer configuration (not shown in the figure) to receive an RF input signal and a signal from one of two local oscillators of the LNA (the local oscillators are not shown in the figure) and produce a signal at an intermediate frequency. The FET control circuit also includes a FET bias current control stage 25 which controls the bias current of FETs F1, F2 & F3. This bias current control stage 25 is connected to the external calibration resistor R1, through which a calibration current flows. The bias current control stage 25 senses this calibration current, and this feature will be described in more detail below. The FET control circuit also comprises a mixer bias current control stage 26 arranged to sense the mixer calibration current through a second calibration resistor R2 and to provide independent control of the bias current through mixer FET F4.

The monolithic support IC 1 also comprises a polarisation control circuit 3, which can also be described as a FET selection circuit. This circuit 3 is arranged to detect the level of a DC component of the voltage signal supplied to the power input 10 and to provide a FET selection control signal to the FET control circuit 2 according to the detected DC level. In this example, according to the detected level of DC on the power input 10 the polarisation control circuit 3 enables one or the other of FETs F1 and F2 (and of course this can also be described as selectively disabling just one of these two FETs). The FET F1 is arranged to process one input signal polarisation to the LNA, and the second FET F2 is arranged to process a different polarisation. Thus, the polarisation control circuit 3 is able to determine which polarisation of input signal the LNA amplifies according to the DC component of voltage applied to the power input 10. In certain examples this power input is also the RF output from the LNA, and the DC component used to select signal polarisation is provided to the LNA by equipment connected downstream. The monolithic support IC also comprises a negative supply generator circuit 5 arranged to generate a negative supply using the regulated output voltage from the regulator 4. This negative supply is provided to the FET control circuit which in turn is then able to provide negative control voltages to the external FETs. In certain embodiments the negative supply generator 5 is also arranged to provide the negative supply to other components of the LNA, external to the support IC 1.

The support IC 1 in FIG. 1 also comprises a tone detector circuit 6 arranged to detect the presence or absence of an AC control component (i.e. a control tone) on the signal provided to the power input 10. The tone detector 6 in turn provides a detection signal to a local oscillator power switch circuit 7 which, according to the presence or absence of the control tone, feeds regulated power supply from the voltage regulator 4 to one or the other of a pair of output terminals 71, 72. Terminal 71 is arranged to supply power to a high-band local oscillator incorporated in the LNA, and terminal 72 provides power to a second, low-band local oscillator.

The LNA of FIG. 7 will now be described in more detail. As mentioned above, FIG. 7 is a block diagram of components of a single universal DBS LNA 100 that comprises a completely monolithic LF support IC 1. The blocks include FET control 2 (providing bias control and FET current setting), polarisation switch control 3, negative supply generator 5, tone detector 6, LO switch 7, internal voltage reference and power regulator 4.

The FET bias control stages protect and control the operation of the several GaAs FETs F1-F4 needed for processing RF signals, which in certain embodiments can be in the range of 5-15 GHz. These depletion mode FETs need well regulated drain voltage supplies, drain current monitoring and control, over-voltage and over-current protected gate drivers that must be cable of sourcing voltages below ground potential.

User control over FET drain operating current is usually required to control both noise performance and gain. Embodiments of the invention partly follow previous partial integration attempts by allowing the user to set drain current with a single external resistor R1 (also referred to as RcalA) that sets up a calibration current. However, experience from these previous attempted integrations has shown that the task of matching (high) drain current monitoring resistors with (low) calibration current monitors leads to excessively large internal components. In certain embodiments of this invention, ratioed bipolar or mosfet transistors are used to perform the matching task, leading to significant die area savings without loss of accuracy.

Many types of DBS LNAs must meet the requirement of being operable to select between one of two input signal polarisations, typically between vertical and horizontal, or between clockwise and anti-clockwise. This has been achieved by selectively enabling one of two input amplifier FETs (each one receives and amplifies one polarisation only). The outputs from both FETs are added and then fed to the next RF amplifier stage. Enabling and disabling these stages is a complex operation as input and output RF impedances must be carefully maintained/controlled if isolation (between polarisations), gain and noise performance is to be maintained. Two design variants have been developed to support this selection in embodiments of the invention. The first technique employed by embodiments of the invention disables the unwanted polarisation by driving the gate of the appropriate FET to a large but controlled negative voltage, completely cutting off all drain current in the device. The drain supply is also disabled, allowing addition of the two polarisation signals using direct connection of the two drains. The second variant, in alternate embodiments, again disables the unwanted polarisation by disabling the drain supply, but it also drives the gate of the appropriate FET to 0V. Being a depletion mode device, the FET is thus driven into a low resistance state (rather than being open circuit as with the first method). LNA designers may prefer the consistency of impedance matching given by this alternate polarisation control. DBS LNA polarisation may be controlled by variation of the DC power supply voltage provided via the RF downfeed cable. Common levels are 13V input or 18V input, to select one or the other of the two polarisations. By integrating power supply regulation into the support IC in embodiments of the invention, this polarisation signal is available without any extra input pins on the package. The extra tasks that are performed in embodiments of the invention to allow this saving is effective filtering out of all unwanted system noise and alternate control signals, without the use of any external components. This is a non trivial task, as allowances for cable voltage drops and controller inaccuracies can reduce the required control signal threshold range to as little as 14.2V to 15.2V. Also, this capability is provided in the presence of AC control signals and noise greater in amplitude than the remaining detection range. Embodiments of the invention use a combination of filters and delay circuits to achieve the difficult task of accurate DC input level detection using integrated components of acceptable size.

It has already been noted that the GaAs amplifier FETs supported in certain embodiments are depletion mode devices which need supplies below (more negative than) ground to control. Since the common RF/DC supply cable cannot directly provide such a supply, it must be generated within the DBS LNA. The support IC in embodiments of the invention provides this supply without the need for any external components. It may also make the supply available to the LNA designer to use with other/new features not immediately met by initial implementations. In certain embodiments, the negative supply generator uses a standard capacitor charge pump circuit. By operating at a very high frequency (>1 MHz), it can provide sufficient current both for gate drivers and any external requirements without the need for an external pump capacitor. Its output is regulated and current limited in certain embodiments to ensure the external FETs cannot be damaged by excessive gate-source or gate-drain voltages. Novel use of isolation diffusions (described below) are necessary to allow the integration of below ground circuitry in an IC process in which the die substrate is wired to ground. Without these techniques, many extra package pins and external components would have been necessary.

Certain monolithic support ICs embodying the invention are able to support DBS LNAs that include band switching. This is achieved by enabling one of two local oscillators. The signal used to select between bands is a low frequency (e.g. 22 kHz) tone added to the DC feed of the LNA. Hence the downfeed cable may be arranged to pass the received RF signal, a DC feed which both supplies the LNA and selects polarisation, and an AC signal that selects the band received. A tone present may select high band, and tone absent may select low band. As previously mentioned, there may be other signals present on the feed cable for purposes of LNA control. Other signals that may be present are DiSEqC signals, MACAB signals, 60 Hz tones (these are all control signals for other equipment that may share the same feed cable), along with power supply noise and interference caused by the LNA itself. The wanted tone must be detected reliably in the presence of many sources of interference. Certain embodiments of the invention use a combination of filtering, level selection and modulation detection to successfully operate in this harsh environment. All signal processing is done without the need for any external components. The input signal is taken directly from the power input to the IC so no input or filter component pins are required for the tone detector.

In certain implementations embodying the invention, band switching is done by activating high side switches that control the DC supply to the two local oscillators. Alternatively, it can also be achieved by gate control of MIMIC devices. Local oscillator supply switching can be problematic. For reasons of RF stability, the supplies to local oscillators must be heavily decoupled. Switching the supplies hence causes significant supply current transients as supply smoothing capacitors are charged. Since these currents are sourced from the DC input to the LNA, which usually has poor (high) source impedance, large voltage transients can be induced on the DC feed by local oscillator switching. This can cause problems as the transients disrupt the same tone signal input as is used to initiate switching. Embodiments of the invention control local oscillator supply switching in such a way as to completely eliminate supply current transients. This is done using a combination of gating, delay circuits and risetime control.

Integrating a power regulator into the DBS LNA controller (i.e. the monolithic support IC) is an important part of reducing package pin count and inter-component wiring. The power input into the LNA is a variable voltage DC feed with high levels of noise and interference. A high performance regulator is needed to use this source to provide a low noise DC supply to the amplifier GaAs FETs, local oscillators and post-mixer amplifiers present in most LNAs. This regulator must be stable, give high input noise rejection (particularly at 22 kHz) and withstand faults (over current and over temperature) without permanent damage. In embodiments of this invention, the regulator is linked to a voltage reference that provides calibrated voltages for the polarisation detector and the regulator, along with over-temperature detection. The regulator detects over-current by comparing a defined fraction of the output current with an internal reference current. This technique avoids the need to place resistors in the high current input or output paths that could degrade output regulation or minimum input operating voltage.

Certain embodiments utilise a monolithic support IC in the form of a QFN (Quad Flat No-Lead) surface mount package. Integrating all LF functions in the manner described has, in certain examples, reduced the required pin count to only 16 pins. This allows the use of a tiny 3 mm by 3 mm by 0.8 mm package to perform all low LF functions required in a DBS LNA. In this package, the IC die is mounted on a metal pad, the back of which is exposed to the PCB. This pad is soldered down to the top metal of the double sided PCB. The reverse side of the PCB adjacent to the IC must also be metalised and the two metal traces should be connected by two or more plated through hole feed throughs. Furthermore, the PCB should be held firmly against the metal alloy housing adjacent to the IC mounting point. This mounting arrangement will ensure that the junction to ambient thermal resistance of the IC will be low enough to dissipate any power lost in the linear regulator of the power supply. The implementation described achieved a junction to ambient thermal resistance of just 30° C./W when mounted in this manner.

FIG. 7 shows the main circuit blocks of the monolithic support IC used in the LNA, and the external components supported by and required with the IC. The IC supports four external GaAs FETs, JA1, JA2, JA3 and JM. Two of the FETs (JA1 and JA2) are used as input amplifiers, one each for either input signal polarisation state, only one of which will be on at any one time. A third FET JA3 is permanently powered and is used as an amplifier. The fourth FET JM is used as a mixer. The drain currents of the amplifier FETs and the mixer FET are user set using two ‘calibration’ resistors R1, R2. The IC provides power outputs for two local oscillators, low band and high band. It also supplies power to any IF band amplifiers required. All circuits are powered from an internal regulator 4, supplied via pin Vin. This pin acts not only as a supply input, but also feeds a voltage comparator 3 for polarisation state control, and a tone detector 6 for low band/high band control.

It will be appreciated from the above that certain embodiments of the invention use a monolithic IC that provides partial linear pre-regulation followed by a two phase switched capacitor down-converter. The pre-regulation performs two tasks. Its weak regulation allows significant noise to appear on its output without coupling the noise to its input. (It sacrifices output voltage regulation for good noise suppression.) The second function is of course to provide a regulated charging current to the capacitors (this can also be thought of as providing a degree of voltage regulation, to reduce the voltage used to charge the capacitors, before the switched capacitor arrangement reduces the voltage further (typically by half) at the output terminal). In multiple output LNBs embodying the invention, multiple pre-regulators can supply a single switching down converter, providing both noise isolation and supply current sharing between power inputs. The simplest single phase down converters (either inductive or capacitive) generate very high input current noise. Multi-phase converters can eliminate this problem but may result in a significant cost increase. By using a two-phase capacitor down converter (switched capacitor), embodiments of the invention provide a largely noise free solution at a cost that is below even single phase inductor based circuits. Also, by including pre-regulation, voltage conversion and LNB fet bias support in one IC in certain embodiments of the invention, the cost of packaging, interconnection components, PCB and LNB housing are all reduced. Embodiments of the invention thus enable power savings and product simplification to be made. Certain embodiments also provide integrated voltage regulation in support IC s for incorporation in multiple output LNBs.

It will also be appreciated that embodiments of the present invention may differ from prior art LNB voltage regulators in that they provide weak pre-regulation, switched capacitor power conversion, two phase power conversion, they may include Fet bias support, they may include polarisation voltage and tone detectors included, and they may be integrated on a monolithic IC. They may also incorporate sophisticated power management strategies, without necessitating external signal routing.

It will also be appreciated that embodiments of the invention are able to provide numerous advantages, including: lower switching noise fed back onto power/RF downfeed cable; higher efficiency than solely linear regulation solutions; lower cost total LNB solutions; and reduced environmental effects.

It will also be appreciated that embodiments of the invention may be utilized in a wide variety of applications, including single and/or multiple output Satellite LNBs, and Satellite Switch Boxes, and satellite signal receiving systems.

1. A voltage regulator comprising:
an input terminal for connection to a power supply providing power at a supply voltage;
an output terminal for connection to a load to provide power to the load at a regulated voltage;
a first capacitor comprising respective first and second electrodes;
a second capacitor comprising respective first and second electrodes;
regulation means arranged to provide a respective regulated charging current from the input terminal to each of said capacitors;
switching means operable to selectively connect the first capacitor's first electrode to receive said respective regulated charging current or to the output terminal, to selectively connect the first capacitor's second electrode to the output terminal or to ground, to selectively connect the second capacitor's first electrode to receive said respective regulated charging current or to the output terminal, and to selectively connect the second capacitor's second electrode to the output terminal or to ground; and
switch control means arranged to control said switching means to alternate between a first configuration in which the first capacitor's first electrode is connected to receive said respective regulated charging current, the first capacitor's second electrode and the second capacitor's first electrode are each connected to the output terminal, and the second capacitor's second electrode is connected to ground, and a second configuration in which the second capacitor's first electrode is connected to receive said respective regulated charging current, the second capacitor's second electrode and the first capacitor's first electrode are each connected to the output terminal, and the first capacitor's second electrode is connected to ground,
wherein the regulation means comprises at least one device through which at least a portion of the respective charging current to at least one of the capacitors is supplied, the device being controllable with a control signal to regulate current flow through the device, the regulation means further comprising control signal supply means connected to the output terminal and arranged to provide said control signal to the device, the control signal being dependent upon voltage at the output terminal such that current flow through the device is regulated according to the voltage at the output terminal.

2. A voltage regulator in accordance with claim 1, wherein the control signal supply means comprises a low pass filter arranged such that the control signal is substantially independent of output voltage components above a frequency threshold.

3. A voltage regulator in accordance with claim 2, wherein said control signal supply means comprises:
a potential divider connected between the output terminal and ground;
an op-amp having an inverting input connected to the potential divider output by the low pass filter; and
a reference voltage source connected between a non-inverting input of the op-amp and ground.

4. A voltage regulator in accordance with claim 3, wherein said control signal is a control voltage provided from an output terminal of the op-amp.

5. A voltage regulator in accordance with claim 1, further comprising an input capacitor connected between the input terminal and ground, and an output capacitor connected between the output terminal and ground.

6. A voltage regulator in accordance with claim 1, further comprising a regulator capacitor connected between an output of the regulation means and ground.

7. A voltage regulator in accordance with claim 1, wherein said device is a field-effect transistor (FET), and said control signal is a control voltage provided to a gate of the FET.

8. A voltage regulator in accordance with claim 1, wherein the regulation means comprises a single said device, the single device being arranged to convey the charging currents to the first and second capacitors.

9. A voltage regulator in accordance with claim 8, wherein said single device is a field-effect transistor (FET) having a drain connected to the input terminal and a gate connected to receive said control signal, and wherein the switching means and switching control means are arranged such that in said first configuration the first capacitor's first electrode is connected to the source of said FET, and in said second configuration the second capacitor's first electrode is connected to the source of said FET.

10. A voltage regulator in accordance with claim 1, wherein the regulation means comprises a first said device controllable with a first control signal to regulate the supply of charging current from the input terminal to the first capacitor, and a second said device controllable with a second control signal to regulate the supply of charging current from the input terminal to the second capacitor, the control signal supply means being arranged to provide said first and second control signals to the first and second devices respectively.

11. A voltage regulator in accordance with claim 10, wherein the first device is a first field-effect transistor (FET) having a drain connected to the input terminal and a source connected to the first capacitor's first electrode, and the second device is a second FET having a drain connected to the input terminal and a source connected to the second capacitor's first electrode.

12. A voltage regulator in accordance with claim 11, wherein the switch control means and the control signal supply means are arranged such that in said first configuration a control voltage is applied to the gate of the first FET to supply a regulated charging current dependent on the output voltage to the first capacitor and the second FET is non-conducting, and such that in said second configuration a control voltage is applied to the gate of the second FET to supply a regulated charging current dependent on the output voltage to the second capacitor and the first FET is non-conducting.

13. A voltage regulator in accordance with claim 1, comprising a plurality of said input terminals, each input terminal being adapted for connection to a respective power supply providing power at a respective supply voltage, and wherein the regulation means is arranged to provide a respective regulated charging current from the input terminals to each of said capacitors,
wherein the regulation means comprises a plurality of said devices, each device corresponding to a respective one of said input terminals and being arranged to convey charging current to the first and second capacitors from the respective input terminal, the control signal supply means being arranged to provide a respective said control signal to each said device such that current flow through each device is regulated according to the voltage at the output terminal.

14. A low noise block (LNB) comprising a voltage regulator in accordance with claim 1.

15. An LNB in accordance with claim 14, further comprising connection means for connecting a cable from a receiver box such that the receiver box can provide power to the LNB via the cable, the input terminal of the voltage regulator being connected to the connection means.

16. An LNB in accordance with claim 15, further comprising a filter network connected between the connection means and the input terminal, the filter network comprising an inductance, a capacitance, and a resistance in parallel with each other.

17. An LNB comprising a voltage regulator in accordance with claim 13, further comprising a plurality of connection means, each connection means being adapted for connecting a respective cable from a respective receiver box such that the receiver box can provide power to the LNB via the cable, each input terminal of the voltage regulator being connected to a respective one of the connection means.

18. An LNB in accordance with claim 15, wherein the LNB is adapted to output signals via the connection means and the cable to the receiver box.

19. An LNB in accordance with claim 14, further comprising at least one amplifier connected to the output terminal to receive power at a regulated voltage.

20. A satellite signal receiving system comprising an low noise block (LNB), a receiver box connected to the LNB by a cable and arranged to supply power to the LNB via the cable at a supply voltage, the LNB comprising a voltage regulator in accordance with claim 1, and the input terminal being connected to the cable, whereby the voltage regulator is operable to provide power at a regulated voltage.

21. (canceled)
